(19) United States
(12) Patent Application Publication
(10) Pub. No.: US 2014/0205013 A1
(43) Pub. Date: Jul. 24, 2014

(54) INTER-PREDICTION METHOD AND APPARATUS

(71) Applicant: Electronics and Telecommunications Research Institute, Daejeon (KR)

(72) Inventors: Jong Ho KIM, Daejeon (KR); Suk Hee CHO, Daejeon (KR); Hyon Gon CHOO, Daejeon (KR); Jin Soo CHOI, Daejeon (KR); Jin Woong KIM, Daejeon (KR)

(73) Assignee: Electronics and Telecommunications Research Institute, Daejeon (KR)

(21) Appl. No.: 14/156,741

(22) Filed: Jan. 16, 2014

(30) Foreign Application Priority Data
Jan. 23, 2013 (KR) 10-2013-0007622

(51) Int. Cl. H04N 19/56

(52) U.S. Cl. CPC H04N 19/0066
USPC 375/240.16

(57) ABSTRACT

A motion estimation method of the present invention includes determining one or more candidate search points for a current block, selecting an initial search point from the one or more candidate search points, and deriving the motion vector of the current block by performing motion estimation within a search range set based on the initial search point.

Priority to Korean patent application number 2013-0007622 filed on Jan. 23, 2013, the entire disclosure of which is incorporated by reference herein, is claimed.

### BACKGROUND OF THE INVENTION

1. Field of the Invention

The present invention relates to video processing and, more particularly, to a motion estimation method and apparatus.

2. Discussion of the Related Art

As broadcast having High Definition (HD) resolution is extended and served nationwide and worldwide, many users are being accustomed to images having high resolution and high picture quality. Accordingly, a lot of institutes are giving impetus to the development of the next-image device. Furthermore, as there is a growing interest in Ultra High Definition (UHD) having resolution 4 times higher than HDTV along with HDTV, there is a need for technology in which an image having higher resolution and higher picture quality is compressed and processed.

In order to compress an image, inter-prediction technology in which a value of a pixel included in a current picture is predicted from temporally anterior and/or posterior pictures, intra-prediction technology in which a value of a pixel included in a current picture is predicted using information about a pixel included in the current picture, entropy encoding technology in which a short sign is assigned to a symbol having high frequency of appearance and a long sign is assigned to a symbol having low frequency of appearance, etc. can be used.

### SUMMARY OF THE INVENTION

An object of the present invention is to provide a video encoding method and apparatus capable of improving video encoding performance.

Another object of the present invention is to provide an inter-prediction method and apparatus capable of improving video encoding performance.

Yet another object of the present invention is to provide a motion estimation method and apparatus capable of improving video encoding performance.

An embodiment of the present invention provides a motion estimation method. The motion estimation method determining one or more candidate search points for a current block, selecting an initial search point from the one or more candidate search points, and deriving the motion vector of the current block by performing motion estimation within a search range set based on the initial search point, wherein in selecting the initial search point, the initial search point may be selected based on the encoding costs of the one or more candidate search points.

The current block may be one of a plurality of lower blocks generated by subdividing an upper block on which motion estimation has already been performed, and the one or more candidate search points may include a point indicated by the motion vector of the upper block based on the zero point of the current block.

The current block may be one of a plurality of lower blocks generated by subdividing an upper block on which motion estimation has already been performed, and the one or more candidate search points may include a point indicated by the motion vector of a block on which motion estimation has already been performed, from among the plurality of lower blocks, based on the zero point of the current block.

The one or more candidate search points may include a point indicated by the motion vector of a collocated block within a reference picture to be used for the inter-prediction of the current block based on the zero point of the current block, and the collocated block may be present in a position that is spatially the same as the current block within the reference picture.

The one or more candidate search points further may include a point indicated by the motion vector of a block neighboring the collocated block within the reference picture based on the zero point of the current block.

The one or more candidate search points may include a point indicated by a combination motion vector derived based on a plurality of motion vectors based on the zero point of the current block. Each of the plurality of motion vectors may be the motion vector of a block on which motion estimation has already been performed.

The current block may be one of a plurality of lower blocks generated by subdividing an upper block on which motion estimation has already been performed. The plurality of motion vectors may include at least one of the origin vector indicated by the zero point, the motion vector of the upper block, the motion vector of a block on which motion estimation has already been performed, from among the plurality of lower blocks, a predicted motion vector of the current block, and the motion vector of a block neighboring the current block.

The combination motion vector may be derived by the mean of the plurality of motion vectors.

The combination motion vector may be derived by the weight sum of the plurality of motion vectors.

A maximum value of the X component values of the plurality of motion vectors may be determined as an X component value of the combination motion vector, and a maximum value of the Y component values of the plurality of motion vectors may be determined as a Y component value of the combination motion vector.

A minimum value of the X component values of the plurality of motion vectors may be determined as an X component value of the combination motion vector, and a minimum value of the Y component values of the plurality of motion vectors may be determined as a Y component value of the combination motion vector.

Selecting the initial search point may include determining a specific number of final candidate search points, from among the one or more candidate search points, based on a correlation between motion vectors indicative of the one or more candidate search points and selecting the initial search point from a specific number of the final candidate search points.

The one or more candidate search points may include a point indicated by a predicted motion vector of the current block based on the zero point of the current block Determining a specific number of the final candidate search points may include determining the final candidate search points based on a difference between the predicted motion vector and each of the remaining motion vectors other than the predicted motion vector, from among the motion vectors indicative of the one or more candidate search points.

The current block may be one of a plurality of lower blocks generated by subdividing an upper block on which motion estimation has already been performed, the one or more candidate search points may include a point indicated by an upper motion vector generated by performing the motion estimation on the upper block based on the zero point of the current block, and determining a specific number of the final candidate search points may include determining the final candidate search points based on a difference between the upper motion vector and each of the remaining motion vectors other than the upper motion vector, from among the motion vectors indicative of the one or more candidate search points.

The current block may be one of a plurality of lower blocks generated by subdividing an upper block on which motion estimation has already been performed, the one or more candidate search points may include a point indicated by a lower motion vector generated by performing motion estimation on a block on which motion estimation has already been performed, from among the plurality of lower blocks, and determining a specific number of the final candidate search points may include determining the final candidate search points based on a difference between the lower motion vector and each of the remaining motion vectors other than the lower motion vectors, from among the motion vectors indicative of the one or more candidate search points.

Determining a specific number of the final candidate search points may include determining the final candidate search points based on a distributed value of each of the motion vectors indicative of the one or more candidate search points.

Another embodiment of the present invention provides an inter-prediction method. The inter-prediction method determining one or more candidate search points for a current block, selecting an initial search point from the one or more candidate search points, deriving the motion vector of the current block by performing motion estimation within a search range set based on the initial search point, and generating a prediction block by performing prediction on the current block based on the derived motion vector, wherein in selecting the initial search point from the one or more candidate search points, the initial search point may be selected based on the encoding costs of the one or more candidate search points.

Yet another embodiment of the present invention provides An inter-prediction apparatus, including a motion estimation unit configured to determine one or more candidate search points for a current block, select an initial search point from the one or more candidate search points, and derive the motion vector of the current block by performing motion estimation within a search range set based on the initial search point, and a motion compensation unit configured to generate a prediction block by performing prediction on the current block based on the derived motion vector, wherein the motion estimation unit may select the initial search point based on the encoding costs of the one or more candidate search points.

Yet further another embodiment of the present invention provides a video encoding method, including determining one or more candidate search points for a current block, selecting an initial search point from the one or more candidate search points, deriving the motion vector of the current block by performing motion estimation within a search range set based on the initial search point, generating a prediction block by performing prediction on the current block based on the derived motion vector, and generating a residual block based on the current block and the prediction block and encoding the residual block, wherein in selecting the initial search point from the one or more candidate search points, the initial search point may be selected based on the encoding costs of the one or more candidate search points.

### BRIEF DESCRIPTION OF THE DRAWINGS

FIG. 1 is a block diagram showing an embodiment of the construction of a video encoding apparatus to which the present invention is applied;

FIG. 2 is a block diagram showing an embodiment of the construction of a video decoding apparatus to which the present invention is applied;

FIG. 3 is a flowchart schematically illustrating an embodiment of an inter-prediction method.

FIG. 4 is a flowchart schematically illustrating an embodiment of a motion estimation process to which the present invention is applied;

FIG. 5 is a diagram schematically showing a method of determining an initial search point in accordance with an embodiment of the present invention;

FIG. 6 is a diagram schematically showing a method of determining candidate search points in accordance with an embodiment of the present invention;

FIG. 7 is a diagram schematically showing a method of determining candidate search points in accordance with another embodiment of the present invention; and

FIG. 8 is a diagram schematically showing a method of determining candidate search points in accordance with yet another embodiment of the present invention.

### DETAILED DESCRIPTION OF THE EMBODIMENTS

Some exemplary embodiments of the present invention are described in detail with reference to the accompanying drawings. Furthermore, in describing the embodiments of this specification, a detailed description of the known functions and constitutions will be omitted if it is deemed to make the gist of the present invention unnecessarily vague.

In this specification, when it is said that one element is ‘connected’ or ‘coupled’ with the other element, it may mean that the one element may be directly connected or coupled with the other element or a third element may be ‘connected’ or ‘coupled’ between the two elements. Furthermore, in this specification, when it is said that a specific element is ‘included’, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element units described in the embodiments of the present invention are independently shown to indicate difference and characteristic functions, and it does not mean that each of the element units is formed of a piece of separate hardware or a piece of software. That is, the element units are arranged and included, for convenience of description, and at least two of the element units may form one element unit or one element may be divided into a plurality of element units and the plurality of divided element units may perform functions. An embodiment into which the elements are integrated or embodiments from which some elements are separated are also included in the scope of the present invention, unless they depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

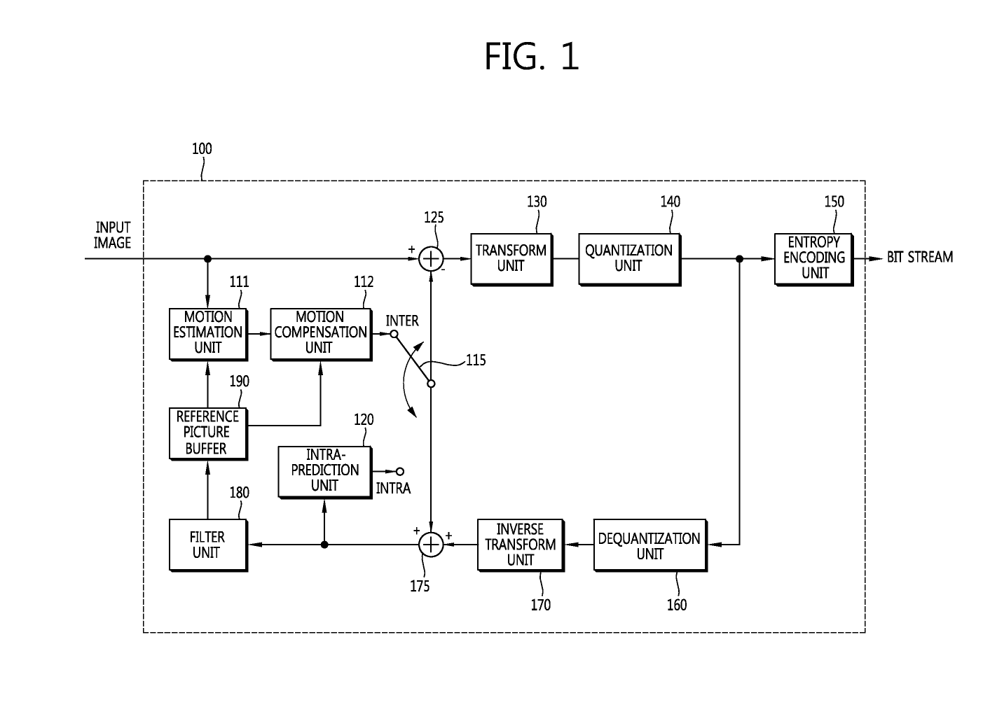

FIG. 1 is a block diagram showing the construction of a video encoding apparatus in accordance with an embodiment of the present invention.

Referring to FIG. 1, the video encoding apparatus 100 includes a motion estimation unit 111, a motion compensation unit 112, an intra-prediction unit 120, a switch 115, a subtractor 125, a transform unit 130, a quantization unit 140, an entropy encoding unit 150, a dequantization unit 160, an inverse transform unit 170, an adder 175, a filter unit 180, and a reference picture buffer 190.

The video encoding apparatus 100 can perform encoding on an input picture in intra-mode or inter-mode and output a bit stream as a result of the encoding. In this specification intra-prediction has the same meaning as intra-frame prediction, and inter-prediction has the same meaning as inter-frame prediction. In the case of intra-mode, the switch 115 can switch to intra mode. In the case of inter-mode, the switch 115 can switch to inter-mode. The video encoding apparatus 100 can generate a prediction block for the input block of an input picture and then encode the residual between the input block and the prediction block.

In the case of intra-mode, the intra-prediction unit 120 can generate the prediction block by performing spatial prediction using values of the pixels of an already encoded block neighboring a current block.

In the case of inter-mode, the motion estimation unit 111 can obtain a motion vector by searching a reference picture, stored in the reference picture buffer 190, for a region that is most well matched with the input block in a motion estimation process. The motion compensation unit 112 can generate the prediction block by performing motion compensation using the motion vector and the reference picture stored in the reference picture buffer 190.

The subtractor 125 can generate a residual block based on the residual between the input block and the generated prediction block. The transform unit 130 can perform transform on the residual block and output a transform coefficient according to the transformed block. Furthermore, the quantization unit 140 can output a quantized coefficient by quantizing the received transform coefficient using at least one of a quantization parameter and a quantization matrix.

The entropy encoding unit 150 can perform entropy encoding based on values calculated (e.g., quantized coefficients) by the quantization unit 140 or an encoding parameter value calculated in an encoding process and output a bit stream according to the entropy encoding.

If entropy encoding is used, the size of a bit stream for a symbol to be encoded can be reduced because the symbol is represented by allocating a small number of bits to a symbol having a high incidence and a large number of bits to a symbol having a low incidence. Accordingly, the compression performance of video encoding can be improved through entropy encoding. The entropy encoding unit 150 can use such encoding methods as exponential Golomb, Context-Adaptive Binary Arithmetic Coding (CABAC), and Context-Adaptive Binary Arithmetic Coding (CABAC) for the entropy encoding.

The video encoding apparatus according to the embodiment of FIG. 1 performs inter-prediction encoding, that is, inter-frame prediction encoding, and thus a currently encoded picture needs to be decoded and stored in order to be used as a reference picture. Accordingly, a quantized coefficient is dequantized by the dequantization unit 160 and is then inversely transformed by the inverse transform unit 170. The dequantized and inversely transformed coefficient is added to the prediction block through the adder 175, thereby generating a reconstructed block.

The reconstructed block experiences the filter unit 180. The filter unit 180 can apply one or more of a deblocking filter, a Sample Adaptive Offset (SAO), and an Adaptive Loop Filter (ALF) to the reconstructed block or the reconstructed picture. The filter unit 180 may also be called an adaptive in-loop filter. The deblocking filter can remove block distortion and blocking artifacts generated at the boundary of blocks. The SAO can add a proper offset value to a pixel value in order to compensate for a coding error. The ALF can perform filtering based on a value obtained by comparing a reconstructed picture with the original picture, and the filtering may be performed only when high efficiency is applied. The reconstructed block that has experienced the filter unit 180 can be stored in the reference picture buffer 190.

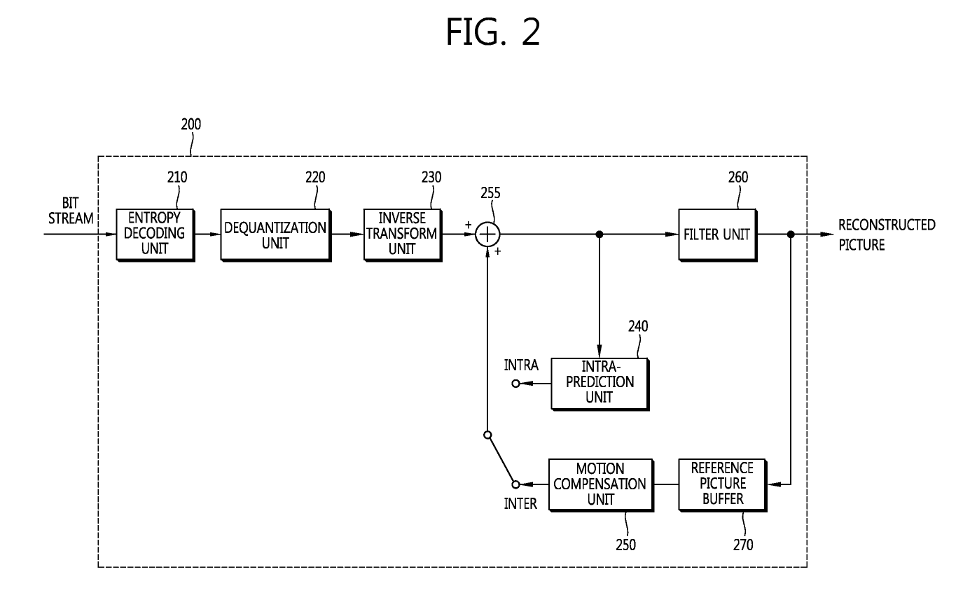

FIG. 2 is a block diagram showing the construction of a video decoding apparatus in accordance with an embodiment of the present invention.

Referring to FIG. 2, the video decoding apparatus 200 includes an entropy decoding unit 210, a dequantization unit 220, an inverse transform unit 230, an intra-prediction unit 240, a motion compensation unit 250, a filter unit 260, and a reference picture buffer 270.

The video decoding apparatus 200 can receive a bit stream outputted from an encoder, perform decoding on the bit stream in intra-mode or inter-mode, and output a reconstructed picture, that is, a restored picture. In the case of intra-mode, a switch can switch to intra-mode. In the case of inter-mode, the switch can switch to inter-mode. The video decoding apparatus 200 can obtain a reconstructed residual block from the received bit stream, generate a prediction block, and then generate a reconstructed block, that is, a restored, by adding the reconstructed residual block to the prediction block.

The entropy decoding unit 210 can generate symbols including a symbol having a quantized coefficient form by performing entropy decoding on the received bit stream according to a probability distribution. In this case, an entropy decoding method is similar to the aforementioned entropy encoding method.

If an entropy decoding method is used, the size of a bit stream for each symbol can be reduced because the symbol is represented by allocating a small number of bits to a symbol having a high incidence and a large number of bits to a symbol having a low incidence. Accordingly, the compression performance of video decoding can be improved through an entropy decoding method.

The quantized coefficient is dequantized by the dequantization unit 220 and is inversely transformed by the inverse transform unit 230. As a result of the dequantization/inverse transform of the quantized coefficient, a residual block can be generated.

In the case of intra-mode, the intra-prediction unit 240 can generate a prediction block by performing spatial prediction using pixel values of already decoded blocks neighboring the current block. In the case of inter-mode, the motion compensation unit 250 can generate a prediction block by performing motion compensation using a motion vector and a reference picture stored in the reference picture buffer 270.

The residual block and the prediction block are added together by an adder 255. The added block experiences the filter unit 260. The filter unit 260 can apply at least one of a deblocking filter, an SAO, and an ALF to the reconstructed block or the reconstructed picture. The filter unit 260 outputs a reconstructed picture, that is, a reconstructed picture. The reconstructed picture can be stored in the reference picture buffer 270 and can be used for inter-frame prediction.

Hereinafter, a block means an image encoding and decoding unit. When an image is encoded and decoded, an encoding or decoding unit means a partition unit when the image is partitioned and encoded or decoded. Thus, the encoding or decoding unit can be called a Coding Unit (CU), a Prediction Unit (PU), a Transform Unit (TU), or a transform block. One block can be subdivided into smaller lower blocks.

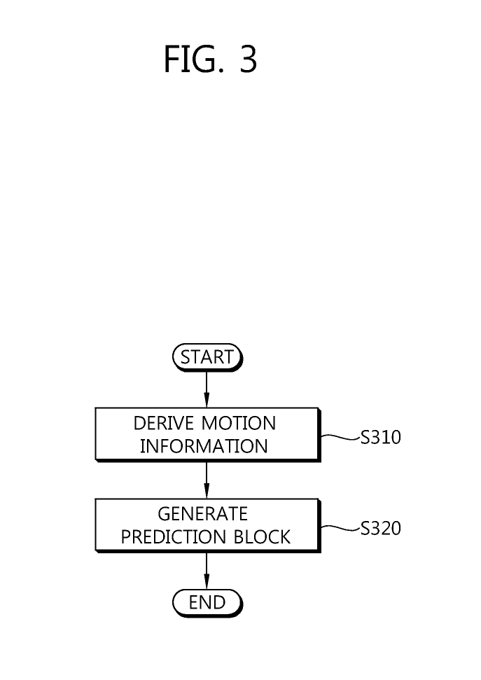

FIG. 3 is a flowchart schematically illustrating an embodiment of an inter-prediction method.

Referring to FIG. 3, each of an encoder and a decoder can derive motion information about a current block at step S310.

In inter-mode, each of the encoder and the decoder can derive motion information about a current block and perform inter-prediction and/or motion compensation based on the derived motion information. The encoder can derive motion information about a current block by performing motion estimation on the current block. Here, the encoder can send information related to the motion information to the decoder. The decoder can derive the motion information of the current block based on the information received from the encoder. Detailed embodiments of a method of performing motion estimation on the current block are described later.

Here, each of the encoder and the decoder can improve encoding/decoding efficiency by using motion information about a reconstructed neighboring block and/or a ‘Col block’ corresponding to a current block within an already reconstructed ‘Col picture’. Here, the reconstructed neighboring block is a block within a current picture that has already been encoded and/or decoded and reconstructed. The reconstructed neighboring block can include a block neighboring a current block and/or a block located at the outside corner of the current block. Furthermore, each of the encoder and the decoder can determine a specific relative position on the basis of a block that is spatially located at the same position as a current block within a Col picture and derive a Col block on the basis of the determined relative point (i.e., a position inside and/outside the block that is spatially located at the same position as the current block). For example, the Col picture can correspond to one of reference pictures included in a reference picture list.

Meanwhile, a motion information encoding method and/or a motion information deriving method may vary depending on a prediction mode of a current block. Prediction modes applied for inter-prediction can include Advanced Motion Vector Prediction (AMVP and merge.

For example, if AMVP is used, each of the encoder and the decoder can generate a predicted motion vector candidate list based on the motion vector of reconstructed neighboring block and/or the motion vector of a Col block. That is, the motion vector of the reconstructed neighboring block and/or the motion vector of the Col block can be used as predicted motion vector candidates. The encoder can send a predicted motion vector index indicative of an optimal predicted motion vector, selected from the predicted motion vector candidates included in the predicted motion vector candidate list, to the decoder. Here, the decoder can select the predicted motion vector of a current block from the predicted motion vector candidates, included in the predicted motion vector candidate list, based on the predicted motion vector index.

In the following description, a predicted motion vector candidate can also be called a Predicted Motion Vector (PMV) and a predicted motion vector can also be called a Motion Vector Predictor (MVP), for convenience of description. A person having ordinary skill in the art will easily understand this distinction.

The encoder can obtain a Motion Vector Difference (MVD) corresponding to a difference between the motion vector of a current block and the predicted motion vector of the current block, encode the MVD, and send the encoded MVD to the decoder. Here, the decoder can decode a received MVD and derive the motion vector of the current block through the sum of the decoded MVD and the predicted motion vector.

Meanwhile, each of the encoder and the decoder may use a median value of the motion vectors of reconstructed neighboring blocks as a predicted motion vector, instead of using the motion vector of the reconstructed neighboring block and/or the motion vector of the Col block as the predicted motion vector. In this case, the encoder can encode a difference between the motion vector value of the current block and the median value and send the encoded difference to the decoder. Here, the decoder can decode the received difference and derive the motion vector of the current block by adding the decoded difference and the median value. This motion vector encoding/decoding method can be called a ‘median method’ instead of an ‘AMVP method’.

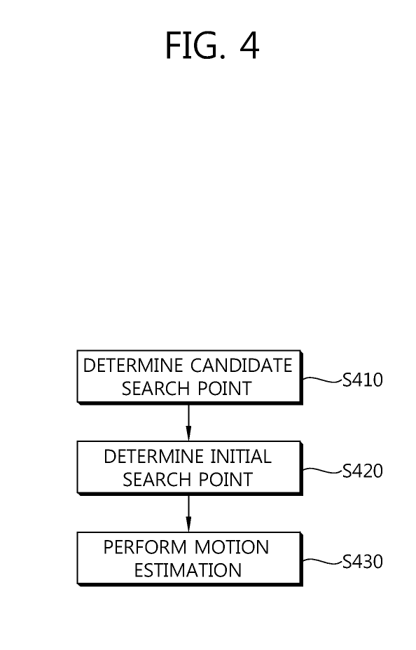

In the following embodiments subsequent to FIG. 4, a motion estimation process when the AMVP method is used is described as an example, but the present invention is not limited to the motion estimation process and can be applied to a case where the median method is used in the same or similar way.

For example, if a merger mode is applied, each of the encoder and the decoder can generate a merger candidate list using motion information about a reconstructed neighboring block and/or motion information about a Col block. That is, if motion information about a reconstructed neighboring block and/or motion information about a Col block are present, each of the encoder and the decoder can use the motion information as merger candidates for a current block.

The encoder can select a merger candidate capable of providing optimal encoding efficiency, from among merger candidates included in a merger candidate list, as motion information about a current block. Here, a merger index indicative of the selected merger candidate can be included in a bit stream and transmitted to the decoder. The decoder can select one of the merger candidates included in the merger candidate list based on the received merger index and determine the selected merger candidate as the motion information of the current block. Accordingly, if a merger mode is used, motion information about a reconstructed neighboring block and/or motion information about a Col block can be used motion information about a current block without change.

In the above-described AMVP and merger modes, in order to derive motion information about a current block, motion information about a reconstructed neighboring block and/or motion information about a Col block can be used. Here, the motion information derived from the reconstructed neighboring block can be called spatial motion information, and the motion information derived from the Col block can be called temporal motion information. For example, a motion vector derived based on the reconstructed neighboring block can be called a spatial motion vector, and a motion vector derived based on the Col block can be called a temporal motion vector.

Referring back to FIG. 3, each of the encoder and the decoder can generate the prediction block of the current block by performing motion compensation on the current block based on the derived motion information at step S320. Here, the prediction block can mean a motion-compensated block that is generated as a result of performing motion compensation on the current block.

FIG. 4 is a flowchart schematically illustrating an embodiment of a motion estimation process to which the present invention is applied. The motion estimation process according to the embodiment of FIG. 4 can be performed by the motion estimation unit of the video encoding apparatus shown in FIG. 1.

Referring to FIG. 4, an encoder can determine a plurality of candidate search points for a current block at step S410.

When performing motion estimation, a search range can be determined based on an initial search point and the motion estimation can be started at the initial search point. That is, the initial search point is a point at which the motion estimation is started when performing the motion estimation, and the initial search point can mean a point that is the center of a search range. Here, the search range can mean a range in which the motion estimation is performed within an image and/or picture.

Accordingly, the encoder can determine a plurality of ‘candidate search points’ as candidates used to determine an optimal initial search point. Detailed embodiments of a method of determining candidate search points are described later.

Referring back to FIG. 4, the encoder can determine a point having a minimum encoding cost, from among the plurality of candidate search points, as an initial search point at step S420.

The encoding cost can mean a cost necessary to encode the current block. For example, the encoding cost can correspond to a value in which an error value between the current block and a prediction block (here, the prediction block can be derived based on motion vectors corresponding to the candidate search points) and/or a value of the Sum of Absolute Difference (SAD), the Sum of Square Error (SSE) and/or the Sum of Square Difference (SSD) indicative of distortion and a motion cost necessary to encode motion vectors (i.e., the motion vectors corresponding to the candidate search points) are added. This can be expressed as in Equation 1 below, for example.

Encoding cost(J)=SAD/SSE/SSD+MV_{Cost} [Equation 1]

In Equation 1, SAD, SSE, and SSD can indicate an error value and/or a distortion value between the current block and the prediction block (here, the prediction block can be derived based on the motion vectors corresponding to the candidate search points) as described above. Particularly, the SAD can mean the sum of the absolute values of error values between a pixel value within the original block and a pixel value within the prediction block (here, the prediction block can be derived based on the motion vectors corresponding to the candidate search points). Furthermore, the SSE and/or the SSD can mean the sum of the squares of error values between a pixel value within the original block he and a pixel value within the prediction block (here, the prediction block can be derived based on the motion vectors corresponding to the candidate search points). MV_{cost} can indicate a motion cost necessary to encode motion vectors.

The encoder can generate a prediction block, corresponding to the current block, regarding each of the plurality of candidate search points. Furthermore, the encoder can calculate an encoding cost for each of the generated prediction blocks and determine a candidate search point, corresponding to a prediction block having the lowest encoding cost, as an initial search point.

Referring back to FIG. 4, the encoder can determine or generate an optimal motion vector for the current block by performing motion estimation on the determined initial search point at step S430.

As described above, the encoder can set a search range based on the initial search point. Here, the initial search point can be located at the center of the search range, and a specific size and/or shape can be determined as the size and/or shape of the search range. Here, the encoder can determine the position of a pixel having a minimum error value (or a minimum encoding cost) by performing motion estimation within the set search range. Furthermore, the position of a pixel having a minimum error value can indicate a position indicated by an optimal motion vector that is generated by performing motion estimation on the current block. That is, the encoder can determine a motion vector, indicating the position of a pixel having a minimum error value (or a minimum encoding cost), as the motion vector of the current block.

For example, the encoder can generate a plurality of prediction blocks on the basis of the positions of pixels within the set search range. Here, the encoder can determine an encoding cost, corresponding to each of the pixels within the search range, based on the plurality of prediction block and the original block. Furthermore, the encoder can determine a motion vector, corresponding to the position of a pixel having the lowest encoding cost, as the motion vector of the current block.

If motion estimation is performed on all pixels within the search range, complexity can be excessively increased. In order to avoid this problem, the encoder may perform a pattern search for performing motion estimation based on only pixels indicated by a specific pattern within the set search range.

When the motion vector of the current block is derived or generated, the encoder can generate a prediction block corresponding to the current block by performing motion compensation on the current block based on the derived or generated motion vector. The encoder can generate a residual block based on a difference between the current block and the prediction block, perform transform, quantization and/or entropy encoding on the generated residual block, and output a bit stream as a result of the transform, quantization and/or entropy encoding.

In accordance with the above-described embodiment, whether or not a pixel having a minimum error value is included in the search range can be determined depending on a position where the initial search point is determined. Furthermore, as a correlation between an initial search point and the position of a pixel having a minimum error value is increased, the encoder can obtain the position of a pixel having a minimum error value more efficiently when performing motion estimation. In order to improve encoding efficiency and reduce the complexity of motion estimation, various methods for determining an initial search point can be used.

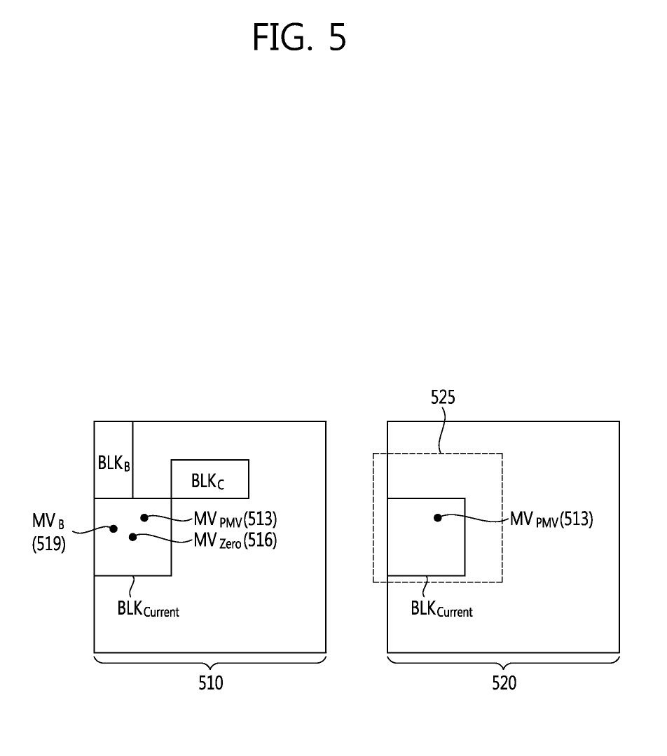

FIG. 5 is a diagram schematically showing a method of determining an initial search point in accordance with an embodiment of the present invention.

FIG. 5 illustrates a current picture 510 to which a current block BLK_{Current} belongs and a reference picture 520 used for the inter-prediction of the current block BLK_{Current}. In the embodiment of FIG. 5, BLK_{B} and BLK_{C} can indicate neighboring blocks that neighbor the current block.

Referring to 510 of FIG. 5, the encoder can determine a plurality of candidate search points for the current block based on the motion vectors of the neighboring blocks that neighbor the current block.

For example, the encoder can determine a point 513, indicated by the predicted motion vector MV_{PMV} of the current block on the basis of a zero point 516, as a candidate search point of the current block. As described above, the predicted motion vector can be determined according to the AMVP method or the median method. For example, if the AMVP method is used, the predicted motion vector MV_{PMV} of the current block can be derived based on the motion vector of a reconstructed neighboring block and/or the motion vector of a Col block. Accordingly, the number of predicted motion vectors for the current block can be plural. In FIG. 5, only the candidate search point 513 indicated by one predicted motion vector MV_{PMV} is illustrated, for convenience of description, but the present invention is not limited thereto. All a plurality of predicted motion vectors used in the AMVP method can be used to determine a candidate search point for the current block.

Furthermore, the encoder can determine the zero point 516, located at the center of the current block BLK_{Current}, as a candidate search point of the current block. Here, the zero point 516 can be indicated by a zero vector MV_{Zero}, and the zero vector MV_{Zero} can be (0,0), for example.

Furthermore, the encoder can determine a point, indicated by the motion vector of a neighboring block that neighbors the current block on the basis of the zero point 516, as a candidate search point of the current block. For example, the encoder can determine a point 519, indicated by the motion vector MV_{B} of the block BLK_{B} located on the most left side, from among blocks neighboring the top of the current block, as a candidate search point for the current block. In the embodiment of FIG. 5, only the point 519 indicated by the motion vector of the block BLK_{B}, from among blocks neighboring the current block BLK_{Current}, is illustrated as a candidate search point, but the present invention is not limited thereto. For example, the encoder may determine a point, indicated by the motion vector of a block that neighbors the left of the current block BLK_{Current}, as a candidate search point and may determine a point, indicated by the motion vector of the block BLK_{C} located at the top right corner outside the current block BLK_{Current}, as a candidate search point.

When the plurality of candidate search points is determined, the encoder can generate a prediction block corresponding to the current block regarding each of the plurality of candidate search points 513, 516, and 519. Furthermore, the encoder can generate an encoding cost for each of the generated prediction blocks. Here, the encoder can determine a candidate search point corresponding to a prediction block having the lowest encoding cost, from among the plurality of candidate search points 513, 516, and 519, as the initial search point. An embodiment of the method of calculating an encoding cost has been described above with reference to FIG. 4, and thus a detailed description thereof is omitted.

Referring to 520 of FIG. 5, for example, the point 513 indicated by the predicted motion vector MV_{PMV} of the current block can be determined as an initial search point. Here, the encoder can generate an optimal motion vector for the current block by performing motion estimation based on the determined initial search point 513.

As described above, the encoder can set a search range 525 based on the initial search point 513. Here, the initial search point 513 can be located at the center of the search range 525, and the search range 525 can have a specific size and/or shape. Here, the encoder can determine the position of a pixel having a minimum error value (or a minimum encoding cost) by performing motion estimation within the set search range 525. The encoder can determine a motion vector indicative of the determined point as the motion vector of the current block.

In accordance with the above-described embodiment, in determining the initial search point, the encoder can refer to the motion vector of a neighboring block that has a similar value to the motion vector of the current block. In most cases, the motion vectors of neighboring blocks neighboring a current block can be similar to the motion vector of the current block. If the number of block partitions is increased because a motion and/or texture within a current block are complicated, however, a correlation between the motion vector of the current block and the motion vector of each of the neighboring blocks can be low.

When a correlation between the motion vector of the current block and the motion vector of the neighboring block is low, if an initial search point is determined with reference to the motion vectors of the neighboring blocks, there is a good possibility that a pixel having a minimum error value may not be included in a search range. Furthermore, there is a good possibility that the distance between the initial search point and the position of the pixel having a minimum error value is distant. In this case, motion estimation may have to be performed at more pixel positions in order to search for a pixel having a minimum error value when carrying out a pattern search.

In order to improve encoding efficiency and reduce the complexity of motion estimation, various methods for determining an initial search point can be used in addition to the method of determining an initial search point with reference to the motion vectors of neighboring blocks that neighbor a current block.

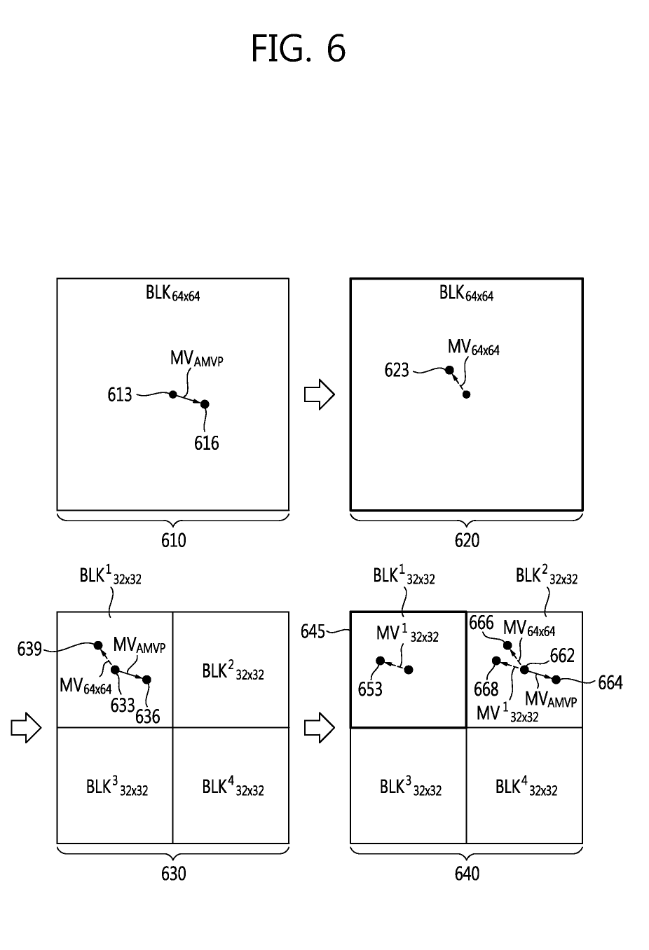

FIG. 6 is a diagram schematically showing a method of determining candidate search points in accordance with an embodiment of the present invention.

In the embodiment of FIG. 6, a dotted-line arrow can mean a motion vector derived by motion estimation, and a solid-line arrow can mean a motion vector (e.g., a predicted motion vector) indicative of a candidate search point determined according to the embodiment of FIG. 5.

In a video encoding process, a target encoding block (i.e., a target encoding block) can be subdivided into smaller lower blocks. In this case, an encoder can perform motion estimation on the target encoding block before the block is subdivided and then perform motion estimation on each of the subdivided lower blocks.

If a current block is a lower block generated by subdividing a target encoding block and motion estimation has already been performed on the target encoding block, the encoder can determine a point, indicated by a motion vector derived by performing motion estimation on the target encoding block, as a candidate search point.

Furthermore, the number of lower blocks generated by subdividing the target encoding block can be plural. Accordingly, before motion estimation is performed on a current block corresponding to a lower block, a lower block on which motion estimation has already been performed may be present within the target encoding block. The lower block on which motion estimation has already been performed can be a neighboring block that neighbors the current block within the target encoding block. In this case, the encoder can determine a point, indicated by the motion vector of the lower block on which motion estimation has already been performed, as a candidate search point.

In the following description, regarding a lower block generated by subdividing a target encoding block, the target encoding block including the lower block is called an upper block, for convenience of description. For example, if a current block is a lower block generated by subdividing a target encoding block, the target encoding block including the current block can be considered as an upper block for the current block. The upper block can have a size greater than the lower block because the lower block is generated by subdividing the upper block.

In 610 of FIG. 6, BLK_{64×64} indicates the highest block, and the size of the highest block can be, for example, 64×64. Since there is no upper block for the highest block BLK_{64×64}, a motion vector that can be used to determine a candidate search point may not be present within the highest block when performing motion estimation on the highest block. That is, a motion vector available within the highest block may not be present because motion estimation has not yet been performed on the highest block.

Accordingly, the encoder can determine a candidate search point according to the method described with reference to FIG. 5.

For example, the encoder can determine a zero point 613, located at the center of the highest block BLK_{64×64}, as the candidate search point of the highest block BLK_{64×64}. Here, the zero point 613 can be indicated by a zero vector, and the zero vector can be, for example, (0,0). Furthermore, the encoder can determine a point 616, indicated by the predicted motion vector MV_{AMVP} of the highest block BLK_{64×64} on the basis of the zero point 613, as the candidate search point of the highest block BLK_{64×64}.

In 610 of FIG. 6, only the point 613 indicated by the zero vector and the point 616 indicated by the predicted motion vector MV_{AMVP} are illustrated as being candidate search points, for convenience of description, but the present invention is not limited thereto. For example, the encoder may determine points, indicated by the motion vectors of neighboring blocks that neighbor the highest block BLK_{64×64}, as candidate search points as in the embodiment of FIG. 5.

In FIG. 6, 620 shows the highest block BLK_{64×64} on which motion estimation has been performed. In 620 of FIG. 6, MV_{64×64} can indicate a motion vector generated by performing motion estimation on the highest block BLK_{64×64}, and MV_{64×64} can indicate a point 623 within the highest block BLK_{64×64}.

Referring to 630 of FIG. 6, the highest block BLK_{64×64} can be subdivided into a plurality of lower blocks BLK¹_{32×32}, BLK²_{32×32}, BLK³_{32×32}, and BLK⁴_{32×32}. Here, in an embodiment, each of the plurality of lower blocks can have a size of 32×32. For example, the lower block BLK¹_{32×32} can be a block located at the left top within the highest block BLK_{64×64,} and the lower block BLK²_{32×32} can be a block located at the right top within the highest block BLK_{64×64}. Furthermore, the lower block BLK³_{32×32} can be a block located at the left bottom within the highest block BLK_{64×64}, and the lower block BLK⁴_{32×32} can be a block located at the right bottom of the highest block BLK_{64×64}.

The encoder can perform motion estimation on the highest block BLK_{64×64} and then perform motion estimation on each of the lower blocks BLK¹_{32×32}, BLK²_{32×32}, BLK³_{32×32}, and BLK⁴_{32×32}. Here, the encoder can perform motion estimation on the lower blocks BLK¹_{32×32}, BLK²_{32×32}, BLK³_{32×32}, and BLK⁴_{32×32} in this order.

Referring back to 630 of FIG. 6, the encoder can perform motion estimation on the first block BLK¹_{32×32}, from among the lower blocks. Here, the encoder can determine at least one of candidate search points 633 and 636, derived according to the embodiment of FIG. 5, and a point 639, indicated by a motion vector MV_{64×64} generated by performing motion estimation on the upper block BLK_{64×64}, as a candidate search point.

For example, the encoder can determine a zero point 633, located at the center of the first block BLK¹_{32×32}, as a candidate search point. Here, the zero point 633 can be indicated by a zero vector. Furthermore, the encoder can determine a point 636, indicated by the predicted motion vector MV_{AMVP} of the first block BLK¹_{32×32} on the basis of the zero point 633, as a candidate search point. Furthermore, the encoder can determine a point 639, indicated by a motion vector MV_{64×64} generated by performing motion estimation on the highest block BLK_{64×64}, as a candidate search point.

In 630 of FIG. 6, only the points 633, 636, and 639 are illustrated as being candidate search points within the first block BLK¹_{32×32}, but the present invention is not limited thereto. For example, the encoder may additionally determine at least one point, indicated by the motion vector of a neighboring block that neighbors the first block BLK¹_{32×32}, as a candidate search point. 640 of FIG. 6 shows an example of a method of determining candidate search points for a second block BLK²_{32×32} if motion estimation has been performed on a first block BLK¹_{32×32} 645 within the highest block BLK_{64×64}. In 640 of FIG. 6, MV¹_{32×32} can indicate a motion vector generated by performing motion estimation on the first block BLK¹_{32×32} 645. MV¹_{32×32} can indicate 653 within the first block BLK¹_{32×32} 645.

Referring to 640 of FIG. 6, the encoder can perform motion estimation on the second block BLK²_{32×32}, from among the lower blocks. Here, the encoder can determine at least one of candidate search points 662 and 664 derived according to the embodiment of FIG. 5, a point 666 indicated by a motion vector MV_{64×64} generated by performing motion estimation on an upper block BLK_{64×64}, and a point 639 indicated by the motion vector MV¹_{32×32} of another lower block BLK¹_{32×32} 645 on which motion estimation has al y been performed within the upper block BLK_{64×64} as a candidate search point. Here, another lower block BLK¹_{32×32} 645 on which motion estimation has already been performed can be a block that neighbors the lower block BLK²_{32×32}, that is, the subject of motion estimation within the upper block BLK_{64×64}.

For example, the encoder can determine a zero point 662, located at the center of the second block BLK²_{32×32}, as a candidate search point. Here, the zero point 662 can be indicated by a zero vector. Furthermore, the encoder can determine a point 664, indicated by the predicted motion vector MV_{AMVP} of the second block BLK²_{32×32} on the basis of the zero point 662, as a candidate search point.

Furthermore, the encoder can determine a point 639, indicated by a motion vector MV_{64×64} generated by performing motion estimation on the highest block BLK_{64×64}, as a candidate search point. Furthermore, the encoder can determine a point 668 indicated by the motion vector MV¹_{32×32} of the lower block BLK¹_{32×32} 645 on which motion estimation has already been performed, from among the lower blocks within the highest block BLK_{64×64}, as a candidate search point.

The encoder can determine a candidate search point for each of the remaining lower blocks BLK³_{32×32} and BLK⁴_{32×32} in a similar way as in the second block BLK²_{32×32}. For example, regarding each of the lower blocks BLK³_{32×32} and BLK⁴_{32×32}, the encoder can determine at least one of a candidate search point derived according to the embodiment of FIG. 5, a point indicated by a motion vector MV_{64×64} generated by performing motion estimation on an upper block BLK_{64×64}, and a point indicated by the motion vector of another lower block on which motion estimation has already been performed within the upper block BLK_{64×64} as a candidate search point.

In 640 of FIG. 6, only the points 662, 664, 666, and 668 are illustrated as being candidate search points within the second block BLK²_{32×32}, but the present invention is not limited thereto. For example, the encoder may additionally determine at least one point, indicated by the motion vector of a neighboring block that neighbors the second block BLK²_{32×32}, as a candidate search point.

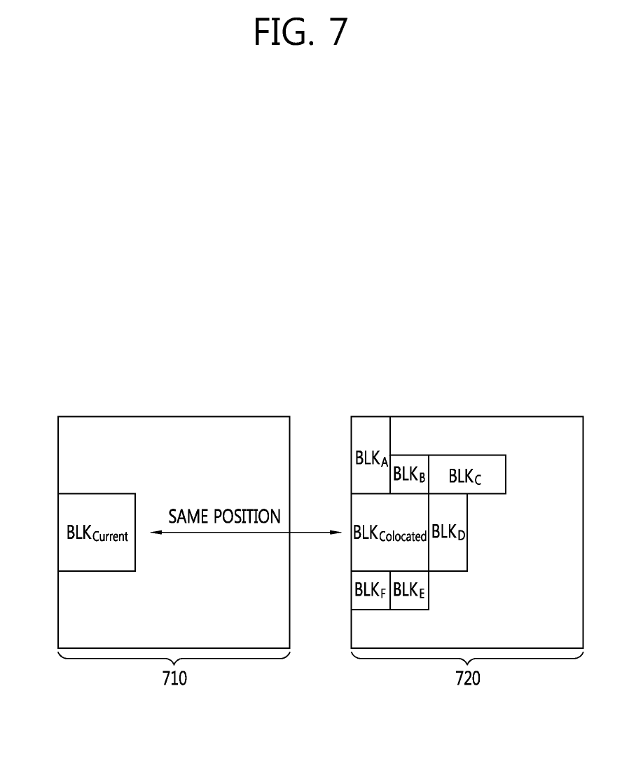

FIG. 7 is a diagram schematically showing a method of determining candidate search points in accordance with another embodiment of the present invention.

FIG. 7 shows a current picture 710 to which a current block BLK_{Current}, that is, the subject of motion estimation, belongs and a reference picture 720 used for the inter-prediction of the current block BLK_{Current}. Here, the reference picture 720 can be a picture on which encoding and/or decoding have already been performed, and all blocks BLK_{Collocated}, BLK_{A}, BLK_{B}, BLK_{C}, BLK_{D}, BLK_{E}, and BLK_{F} belonging to the reference picture 720 can be blocks on which encoding and/or decoding have been completed. In the embodiment of FIG. 7, a motion vector for BLK_{Collocated} is called MV_{Collocated}, and motion vectors for BLK_{A}, BLK_{B}, BLK_{C}, BLK_{D}, BLK_{E}, and BLK_{F} are called MV_{A}, MV_{B}, MV_{C}, MV_{D}, MV_{E}, and MV_{F}, respectively.

An encoder can determine points, indicated by the motion vectors of the blocks belonging to the reference picture 720, as the candidate search points of the current block BLK_{Current} when performing motion estimation.

For example, the encoder can determine a point, indicated by the motion vector MV_{Collocated} of the block BLK_{Collocated} that is spatially located at the same position (i.e., an overlapped point) as the current block BLK_{Current} within the reference picture 720, as the candidate search point of the current block BLK_{Current}. Here, the block BLK_{Collocated} spatially located at the same position (i.e., an overlapped point) as the current block BLK_{Current} within the reference picture 720 can be called a ‘collocated block’.

Furthermore, the encoder can determine at least one of points, indicated by the motion vectors MV_{A}, MV_{B}, MV_{C}, MV_{D}, MV_{E}, and MV_{F} of the neighboring blocks BLK_{A}, BLK_{B}, BLK_{C}, BLK_{D}, BLK_{E}, and BLK_{F} that neighbor the collocated block BLK_{Collocated} within the reference picture 720, as the candidate search point of the current block BLK_{Current}. In FIG. 7, since the blocks within the reference picture 720 are blocks on which encoding and/or decoding have already been performed, the motion vectors of not only the collocated block, but also all the blocks neighboring the collocated block can be used to determine the candidate search points of the current block.

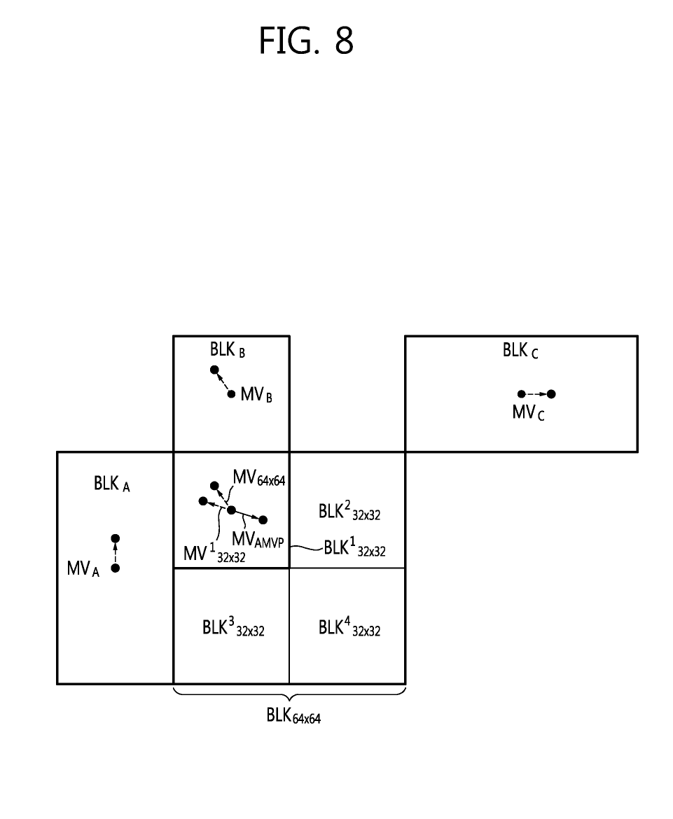

FIG. 8 is a diagram schematically showing a method of determining candidate search points in accordance with yet another embodiment of the present invention.

In the embodiment of FIG. 8, a dotted-line arrow can mean a motion vector derived by motion estimation, and a solid-line arrow can mean a motion vector (e.g., a predicted motion vector) indicative of a candidate search point determined according to the embodiment of FIG. 5.

FIG. 8 shows an upper block BLK_{64×64}, lower blocks BLK¹_{32×32}, BLK²_{32×32}, BLK³_{32×32}, and BLK⁴_{32×32} generated by subdividing the upper block, and blocks BLK_{A}, BLK_{B}, and BLK_{C} that neighbor the upper block. For example, the size of the upper block BLK_{64×64} can be 64×64, and the size of each of the lower blocks BLK¹_{32×32}, BLK²_{32×32}, BLK³_{32×32}, and BLK⁴_{32×32} can be 32×32. For example, motion estimation can be performed on the lower blocks BLK¹_{32×32}, BLK²_{32×32}, BLK³_{32×32}, and BLK⁴_{32×32} in this order.

Furthermore, in FIG. 8, MV_{64×64} can indicate a motion vector generated by performing motion estimation on the upper block BLK_{64×64}, and MV¹_{32×32} can indicate a motion vector generated by performing motion estimation on the first lower block BLK¹_{32×32}. Furthermore, MV_{A}, MV_{B}, and MV_{C} can indicate respective motion vectors generated by performing motion estimation on each of the neighboring blocks BLK_{A}, BLK_{B}, and BLK_{C}. Furthermore, MV_{AMVP} can indicate a predicted motion vector.

As described above with reference to FIGS. 5 to 7, an encoder can determine the candidate search point of a target motion estimation block in various ways. For example, it is assumed that a current block is a lower block generated by subdividing an upper block. Here, the encoder can determine at least one of a zero point (here, a motion vector indicative of a zero point is hereinafter called a first motion vector), a point indicated by a predicted motion vector (hereinafter referred as a second motion vector), a point indicated by the motion vector (hereinafter referred as a third motion vector) of a neighboring block that neighbors the target motion estimation block, a point indicated by the motion vector (hereinafter referred as a fourth motion vector) of an upper block for the target motion estimation block, a point indicated by the motion vector (hereinafter referred as a fifth motion vector) of a block on which motion estimation has already been performed, from among lower blocks within the upper block, a point indicated by the motion vector (hereinafter referred as a the sixth motion vector) of a collocated block within a reference picture, and a point indicated by the motion vector (hereinafter referred as a seventh motion vector) of a block that neighbors the collocated block within the reference picture as the candidate search point of the target motion estimation block.

The first motion vector to the seventh motion vector can form a set of motion vectors available for the motion estimation of a current block. In the following description, a set of motion vectors available for the motion estimation of a current block is hereinafter called a ‘motion vector set’, for convenience of description.

An encoder can generate a new motion vector by combining one or more of a plurality of motion vectors that forms a motion vector set. For example, the encoder can use the mean, a maximum value, a minimum value and/or a value generated by a weight sum, of one or more of motion vectors included in a motion vector set, as a new motion vector value. Here, the encoder can determine a point, indicated by the new motion vector, as a candidate search point.

In FIG. 8, it is assumed that the encoder performs motion estimation on the second block BLK²_{32×32} of the lower blocks within the upper block BLK_{64×64}. That is, in FIG. 8, a current block that is the subject of motion estimation can be the second block BLK²_{32×32}, from among the lower blocks within the upper block BLK_{64×64}.

Furthermore, the upper block BLK_{64×64}, the blocks BLK_{A}, BLK_{B}, and BLK_{C} neighboring the upper block, and the first lower block BLK¹_{32×32} can be blocks on which motion estimation has already been performed. In this case, each of the blocks on which motion estimation has already been performed can include a motion vector generated by performing the motion estimation.

Accordingly, in FIG. 8, a motion vector set, that is, a set of motion vectors available for the motion estimation of the current block BLK²_{32×32}, for example, can include the motion vector MV_{64×64} of the upper block BLK_{64×64}, the motion vectors MV_{A}, MV_{B}, and MV_{C} of the neighboring blocks BLK_{A}, BLK_{B}, and BLK_{C} neighboring the upper block BLK_{64×64}, the motion vector MV¹_{32×32} of the first lower block BLK¹_{32×32}, and the predicted motion vector MV_{AMVP}. In FIG. 8, it is assumed that MV_{64×64} is (−6,6), MV¹_{32×32} is (−5,2), MV_{AMVP} is (8,−2), MV_{A} is (0,10), MV_{B} is (−3,10), and MV_{C} is (6,0).

Here, the encoder can generate a new motion vector by combining one or more of the plurality of motion vectors included in the motion vector set. In FIG. 8, it is assume that motion vectors used to generate a new motion vector, form among the plurality of motion vectors included in the motion vector set, include the motion vector MV_{64×64} of the upper block BLK_{64×64}, the motion vector MV¹_{32×32} of the first lower block, and the predicted motion vector MV_{AMVP}.

For example, the encoder can determine the mean of the motion vectors as a new motion vector. In this case, the new motion vector can be calculated in accordance with Equation 2 below.

X=(8−6−5)/3=−1,Y=(−2+6+2)/3=2

MV_{MEAN}=(X,Y)=(−1,2) [Equation 2]

In Equation 2, MV_{MEAN} can indicate a new motion vector derived based on the mean of motion vectors included in a motion vector set.

For another example, the encoder can determine a maximum value of the X components of the motion vectors as an X component value of a new motion vector and can determine a maximum value of the Y components of the motion vectors as a Y component value of the new motion vector. In this case, the new motion vector can be calculated in accordance with Equation 3 below.

X=8,Y=6,MV_{MAX}=(8,6) [Equation 3]

In Equation 3, MV_{MAX} can indicate a motion vector newly derived according to the above-described method.

For yet another example, the encoder can determine a minimum value of the X components of the motion vectors as an X component value of a new motion vector and can determine a minimum value of the Y components of the motion vectors as a Y component value of the new motion vector. In this case, the new motion vector can be calculated in accordance with Equation 4 below.

X=−6,Y=−2,MV_{MIN}=(−6,−2) [Equation 4]

In Equation 4, MV_{MIN} can indicate a motion vector newly derived according to the above-described method.

If a new motion vector is generated by combining one or more of the plurality of motion vectors included in the motion vector set, the encoder can determine a point, indicated by the generated motion vector, as the candidate search point of the current block BLK²_{32×32}.

Meanwhile, if a plurality of candidate search points is determined as in the above-described embodiments, the encoder may determine a point having a minimum encoding cost, from among the plurality of candidate search points, as an initial search point as described above with reference to FIG. 4. For example, the encoder may calculate an encoding cost for each of all candidate search points derived for a target motion estimation block and determine an initial search point based on a result of the calculation. Here, the method of calculating an encoding cost for each of candidate search points can have great complexity. In order to solve this problem, the encoder may reduce the number of candidate search points based on a correlation between motion vectors in a process of determining an initial search point and then determine the initial search point from among the reduced candidate search points.

In an embodiment, the encoder may remove a point indicated by a motion vector having the greatest difference from a predicted motion vector PMV, from among a plurality of candidate search points derived for a current block. In another embodiment, the encoder may select a specific number (e.g., 2, 3, or 4) of motion vectors from a plurality of candidate search points, derived for a current block, in the order of greater differences from a predicted motion vector PMV and remove points indicated by the selected motion vectors. Here, the difference between the motion vectors may correspond to, for example, the sum of the absolute value of a difference between the X components of the motion vectors and the absolute value of a difference between the Y components of the motion vectors.

In yet another embodiment, the encoder may use only a point indicated by a motion vector having the smallest difference from a predicted motion vector PMV, from among a plurality of candidate search points derived for a current block, and a point indicated by the predicted motion vector PMV, as candidate search points. That is, in this case, the encoder may remove all the remaining points other than the point indicated by the motion vector having the smallest difference from the predicted motion vector PMV and the point indicated by the predicted motion vector PMV. In yet further another embodiment, the encoder may select a specific number (e.g., 2, 3, or 4) of motion vectors from motion vectors, indicated by a plurality of candidate search points derived for a current block, in the order of smaller differences from a predicted motion vector PMV and use points indicated by the selected motion vectors and a point indicated by the predicted motion vector PMV as candidate search points. That is, in this case, the encoder may remove all the remaining points other than the points indicated by a specific number of the motion vectors and the predicted motion vector PMV.

For example, in FIG. 8, it is assumed that points indicated by the motion vectors MV_{64×64}, MV¹_{32×32}, MV_{AMVP}, MV_{A}, MV_{B}, and MV_{C} are determined as the candidate search points of the current block MV²_{32×32}. For example, the MV_{64×64} may be (−6,6), the MV¹_{32×32} may be (−5,2), the MV_{AMVP} may be (8,−2), the MV_{A} may be (0,10), the MV_{B} may be (−3,10), and the MV_{C} may be (6,0). Here, a difference between the predicted motion vector MV_{AMVP} and each of the motion vectors MV_{64×64}, MV¹_{32×32}, MV_{A}, MV_{B}, and MV_{C} indicated by the respective candidate search points may be calculated in accordance with Equation 5 below.

|MV_{AMVP}−MV_{64×64}|=|{8−(−6)}|+|(−2−6)|=22

|MV_{AMVP}−MV¹_{32×=}|=|{8−(5)}|+|(−2−2)|=32

|MV_{AMVP}−MV_{A}|=|8−0|+|(−2−10)|=20

|MV_{AMVP}−MV_{B}|=|{8−(−3)}|+|(−2−10)|=23

|MV_{AMVP}−MV_{C}|=∥8−6|+|(−2−0)|=4 [Equation 5]

For example, the encoder may remove the point, indicated by the motion vector MV_{B} having the greatest difference from the predicted motion vector MV_{AMVP}, from candidate search points. For another example, the encoder may remove the point, indicated by the motion vector MV_{B} having the greatest difference from the predicted motion vector MV_{AMVP}, and the point, indicated by the motion vector MV_{64×64} having the second greatest difference from the predicted motion vector MV_{AMVP} which is next to the motion vector MV_{B}, from candidate search points. Here, a difference between the motion vector MV_{64×64} and the motion vector MV_{B} may correspond to, for example, the sum of the absolute value of a difference between the X components of the motion vectors and the absolute value of a difference between the Y components of the motion vectors.

For another example, the encoder may use only the points, indicated by the predicted motion vector MV_{AMVP} and the motion vector MV_{C} having the smallest difference from the predicted motion vector MV_{AMVP}, as candidate search points. In this case, the encoder may remove all the remaining points other than the points, indicated by the motion vectors MV_{AMVP} and MV_{C}, from the candidate search points. For yet another example, the encoder may use the point indicated by the predicted motion vector MV_{AMVP}, the point indicated by the motion vector MV_{C} having the smallest difference from the predicted motion vector MV_{AMVP}, and the point, indicated by the motion vector MV¹_{32×32} having the second smallest difference from the predicted motion vector MV_{AMVP} which is next to the motion vector MV_{C}, as candidate search points. In this case, the encoder may remove all the remaining points other than the points, indicated by the motion vectors MV_{AMVP}, MV_{C}, and MV¹_{32×32}, from the candidate search points.

As yet another embodiment, the encoder may remove a point indicated by a motion vector having the greatest difference from the motion vector of an upper block, from among a plurality of candidate search points derived for a current block. For example, the encoder may select a specific number (e.g., 2, 3, or 4) of motion vectors from motion vectors, indicated by a plurality of candidate search points derived for a current block, in the order of greater differences from the motion vector of an upper block and removes points indicated by the selected motion vector.

As yet further another embodiment, the encoder may use only a point indicated by a motion vector having the smallest difference from the motion vector of an upper block, from among a plurality of candidate search points derived for a current block, and a point indicated by the motion vector of the upper block, as candidate search points. That is, in this case, the encoder may remove all the remaining points other than the point indicated by the motion vector having the smallest difference from the motion vector of the upper block and the point indicated by the motion vector of the upper block. Furthermore, the encoder may select a specific number (e.g., 2, 3, or 4) of motion vectors from a plurality of candidate search points derived for a current block in the order of smaller differences from the motion vector of an upper block and use only points indicated by the selected motion vectors and a point indicated by the motion vector of an upper block as candidate search points. That is, in this case, the encoder may remove all the remaining points other than the points indicated by a specific number of the motion vectors and the motion vector of the upper block.

For example, in FIG. 8, it is assumed that points indicated by the motion vectors MV_{64×64}, MV¹_{32×32}, MV_{AMVP}, MV_{A}, MV_{B}, and MV_{C} are determined as the candidate search points of the current block MV²_{32×32}. For example, the MV_{64×64} may be (−6,6), the MV¹_{32×32} may be (−5,2), the MV_{AMVP} may be (8,−2), the MV_{A} may be (0,10), the MV_{B} may be (−3,10), and the MV_{C} may be (6,0). Here, a difference between the motion vector MV_{64×64} of the upper block and each of the motion vectors MV¹_{32×32}, MV_{AMVP}, MV_{A}, MV_{B}, and MV_{C} indicative of the candidate search points can be calculated in accordance with Equation 6 below.

|MV_{64×64}−MV_{AMVP}|=|−6−8|+|(6−(−2)}|=22

|MV_{64×64}−MV¹_{32×32}|=|{−6−(−5)}|+|(6−2)|=5

|MV_{64×64}−MV_{A}|=|−6−0|+|6−10|=10

|MV_{64×64}−MV_{B}|=|{−6−(−3)}|+|6−10|=7

|MV_{64×64}−MV_{C}|=|−6−6|+|6−0|=18 [Equation 6]

Here, for example, the encoder may remove the point, indicated by the motion vector MV_{AMVP} having the greatest difference from the motion vector MV_{64×64} of the upper block, from candidate search points. For another example, the encoder may remove the point, indicated by the motion vector MV_{AMVP} having the greatest difference from the motion vector MV_{64×64} of the upper block, and the point, indicated by the motion vector MV_{C} having the second greatest difference from the motion vector MV_{64×64} of the upper block which is next to the motion vector MV_{AMVP}, from candidate search points.

For another example, the encoder may use only the point indicated by the motion vector MV_{64×64} of the upper block and the point indicated by the motion vector MV¹_{32×32} having the smallest difference from the motion vector MV_{64×64} of the upper block as candidate search points. In this case, the encoder may remove all the remaining points other than the points indicated by the motion vectors MV_{64×64} and MV¹_{32×32} from the candidate search points. For yet another example, the encoder may use only the point indicated by the motion vector MV_{64×64} of the upper block, the point indicated by the motion vector MV¹_{32×32} having the smallest difference from the motion vector MV_{64×64} of the upper block, and the point indicated by the motion vector MV_{B} having the second smallest difference from the motion vector MV_{64×64} of the upper block which is next to the motion vector MV¹_{32×32} as candidate search points. In this case, the encoder may remove all the remaining points other than the points indicated by the motion vectors MV_{64×64}, MV¹_{32×32}, and MV_{B} from the candidate search points.

As yet further another embodiment, if a current block (e.g., MV²_{32×32 of} FIG. 8) is a lower block generated by subdividing an upper block (e.g., MV_{64×64} of FIG. 8), another lower block (e.g., MV¹_{32×32} of FIG. 8) on which motion estimation has already been performed may be present within the upper block. Hereinafter, ‘another lower block’ may mean a lower block which belongs to the same upper block as a current block and on which motion estimation has already been performed.

In this case, for example, the encoder may remove a point indicated by a motion vector having the greatest difference from the motion vector of another lower block (e.g., MV¹_{32×32} of FIG. 8), from among a plurality of candidate search points derived for the current block. For another example, the encoder may select a specific number (e.g., 2, 3, or 4) of motion vectors from the plurality of candidate search points, derived for the current block, in the order of greater difference from the motion vector of another lower block (e.g., MV¹_{32×32} of FIG. 8) and remove points indicated by the selected motion vectors.

Furthermore, in this case, the encoder may use only a point indicated by a motion vector having the smallest difference from the motion vector of another lower block (e.g., MV¹_{32×32} of FIG. 8), from among the plurality of candidate search points derived for the current block, and a point indicated by the motion vector of another lower block (e.g., MV¹_{32×32} of FIG. 8) as candidate search points. That is, the encoder may remove all the remaining points other than the point indicated by the motion vector having the smallest difference from the motion vector of another lower block (e.g., MV¹_{32×32} of FIG. 8) and the point indicated by the motion vector of another lower block (e.g., MV¹_{32×32} of FIG. 8). For yet another example, the encoder may select a specific number (e.g., 2, 3, or 4) of motion vectors from the plurality of candidate search points derived for the current block in the order of smaller difference from the motion vector of another lower block (e.g., MV¹_{32×32} of FIG. 8) and use only points indicated by the selected motion vectors and a point indicated by the motion vector of another lower block (e.g., MV¹_{32×32} of FIG. 8) as candidate search points. That is, in this case, the encoder may remove all the remaining points other than the points indicated by a specific number of the motion vectors and the point indicated by the motion vector of another lower block (e.g., MV¹_{32×32} of FIG. 8).

A detailed embodiment of the method of determining points to be removed from candidate search points on the basis of the motion vector of another lower block is similar to Equations 5 and 6, and thus a detailed description thereof is omitted.

As yet another embodiment, the encoder may calculate a distributed value for each of motion vectors on the basis of motion vectors indicative of a plurality of candidate search points derived for a current block. Here, the encoder may determine points to be removed from candidate search points based on the distributed values.

For example, the encoder may remove a point indicated by a motion vector having the greatest distributed value, from among the plurality of candidate search points derived for the current block. For another example, the encoder may select a specific number (e.g., 2, 3, or 4) of motion vectors from motion vectors indicated by the plurality of candidate search points derived for the current block in the order of higher distributed value and remove points indicated by the selected motion vector.

For another example, the encoder may use only a point indicated by a motion vector having the smallest distributed value, from among the plurality of candidate search points derived for the current block, as a candidate search point. That is, in this case, the encoder may remove all the remaining points other than the point indicated by the motion vector having the smallest distributed value. Furthermore, the encoder may select a specific number (e.g., 2, 3, or 4) of motion vectors from among the plurality of candidate search points derived for the current block in the order of smaller distributed value and use only points indicated by the selected motion vectors as candidate search points. That is, in this case, the encoder may remove all the remaining points other than the points indicated by a specific number of the motion vectors.

A detailed embodiment of the method of determining points to be removed from candidate search points on the basis of distributed values is similar to Equations 5 and 6, and thus a detailed description thereof is omitted.

When points to be removed, from among a plurality of candidate search points derived for a current block, are determined according to the above-described embodiments, the encoder can determine an optimal initial search point, from among the remaining candidate search points, other than the removed points. For example, the encoder can determine a point having a minimum encoding cost, from among the remaining candidate search points other than the removed points, as an initial search point.

In accordance with the aforementioned embodiments, the encoder can refer to the motion vector of a block having a high correlation with a current block in performing motion estimation on the current block. In particular, the encoder can search for the position of a pixel having a minimum error value more efficiently because each of an upper block to which a current block belongs and another lower block belonging to the upper block has a high correlation with the current block.

Furthermore, if a process of determining candidate search points and a process of determining an initial search point are performed according to the aforementioned embodiments, there is a high possibility that the position of a pixel having a minimum error value can be included in a search range. Furthermore, in accordance with the aforementioned embodiments, in a motion estimation process, such as a pattern search, the encoder can search for the position of a pixel having a minimum error value more quickly. Accordingly, in accordance with the present invention, encoding performance can be improved.

In accordance with the video encoding method of the present invention, video encoding performance can be improved.

In accordance with the inter-prediction method of the present invention, video encoding performance can be improved.

In accordance with the motion estimation method of the present invention, video encoding performance can be improved.

In the above exemplary system, although the methods have been described based on the flowcharts in the form of a series of steps or blocks, the present invention is not limited to the sequence of the steps, and some of the steps can be performed in a difference order from that of other steps or can be performed simultaneous to other steps. Furthermore, the aforementioned embodiments include various examples. For example, a combination of some embodiments should also be understood as an embodiment of the present invention.

The above embodiments include various aspects of examples. Although all possible combinations for representing the various aspects may not be described, those skilled in the art will appreciate that other combinations are possible. Accordingly, the present invention should be construed as including all other replacements, modifications, and changes which fall within the scope of the claims.

What is claimed is:

1. A motion estimation method, comprising:
determining one or more candidate search points for a current block;
selecting an initial search point from the one or more candidate search points; and
deriving a motion vector of the current block by performing motion estimation within a search range set based on the initial search point,
wherein selecting the initial search point comprises selecting the initial search point based on encoding costs of the one or more candidate search points.

2. The motion estimation method of claim 1, wherein:
the current block is one of a plurality of lower blocks generated by subdividing an upper block on which motion estimation has already been performed, and
the one or more candidate search points comprise a point indicated by a motion vector of the upper block based on a zero point of the current block.

3. The motion estimation method of claim 1, wherein:
the current block is one of a plurality of lower blocks generated by subdividing an upper block on which motion estimation has already been performed, and
the one or more candidate search points comprise a point indicated by a motion vector of a block on which motion estimation has already been performed, from among the plurality of lower blocks, based on a zero point of the current block.

4. The motion estimation method of claim 1, wherein:
the one or more candidate search points comprise a point indicated by a motion vector of a collocated block within a reference picture to be used for inter-prediction of the current block based on a zero point of the current block, and
the collocated block is present in a position spatially identical with the current block within the reference picture.

5. The motion estimation method of claim 4, wherein the one or more candidate search points further comprise a point indicated by a motion vector of a block neighboring the collocated block within the reference picture based on the zero point of the current block.

6. The motion estimation method of claim 1, wherein:
the one or more candidate search points comprise a point indicated by a combination motion vector derived based on a plurality of motion vectors based on a zero point of the current block, and
each of the plurality of motion vectors is a motion vector of a block on which motion estimation has already been performed.

7. The motion estimation method of claim 6, wherein:
the current block is one of a plurality of lower blocks generated by subdividing an upper block on which motion estimation has already been performed, and
the plurality of motion vectors comprises at least one of an origin vector indicated by the zero point, a motion vector of the upper block, a motion vector of a block on which motion estimation has already been performed, from among the plurality of lower blocks, a predicted motion vector of the current block, and a motion vector of a block neighboring the current block.

8. The motion estimation method of claim 6, wherein the combination motion vector is derived by a mean of the plurality of motion vectors.

9. The motion estimation method of claim 6, wherein the combination motion vector is derived by a weight sum of the plurality of motion vectors.

10. The motion estimation method of claim 6, wherein:
a maximum value of X component values of the plurality of motion vectors is determined as an X component value of the combination motion vector, and
a maximum value of Y component values of the plurality of motion vectors is determined as a Y component value of the combination motion vector.

11. The motion estimation method of claim 6, wherein:
a minimum value of X component values of the plurality of motion vectors is determined as an X component value of the combination motion vector, and
a minimum value of Y component values of the plurality of motion vectors is determined as a Y component value of the combination motion vector.

12. The motion estimation method of claim 1, wherein selecting the initial search point comprises:
determining a specific number of final candidate search points, from among the one or more candidate search points, based on a correlation between motion vectors indicative of the one or more candidate search points; and
selecting the initial search point from a specific number of the final candidate search points.

13. The motion estimation method of claim 12, wherein:
the one or more candidate search points comprises a point indicated by a predicted motion vector of the current block based on a zero point of the current block, and
determining a specific number of the final candidate search points comprises determining the final candidate search points based on a difference between the predicted motion vector and each of remaining motion vectors other than the predicted motion vector, from among the motion vectors indicative of the one or more candidate search points.

14. The motion estimation method of claim 12, wherein:
the current block is one of a plurality of lower blocks generated by subdividing an upper block on which motion estimation has already been performed,
the one or more candidate search points comprise a point indicated by an upper motion vector generated by performing the motion estimation on the upper block based on a zero point of the current block, and
determining a specific number of the final candidate search points comprises determining the final candidate search points based on a difference between the upper motion vector and each of remaining motion vectors other than the upper motion vector, from among the motion vectors indicative of the one or more candidate search points.

15. The motion estimation method of claim 12, wherein:
the current block is one of a plurality of lower blocks generated by subdividing an upper block on which motion estimation has already been performed,
the one or more candidate search points comprise a point indicated by a lower motion vector generated by performing motion estimation on a block on which motion estimation has already been performed, from among the plurality of lower blocks, and
determining a specific number of the final candidate search points comprises determining the final candidate search points based on a difference between the lower motion vector and each of remaining motion vectors other than the lower motion vectors, from among the motion vectors indicative of the one or more candidate search points.

16. The motion estimation method of claim 12, wherein determining a specific number of the final candidate search points comprises determining the final candidate search points based on a distributed value of each of the motion vectors indicative of the one or more candidate search points.

17. An inter-prediction apparatus, comprising:
a motion estimation unit configured to determine one or more candidate search points for a current block, select an initial search point from the one or more candidate search points, and derive a motion vector of the current block by performing motion estimation within a search range set based on the initial search point, and
a motion compensation unit configured to generate a prediction block by performing prediction on the current block based on the derived motion vector,
wherein the motion estimation unit selects the initial search point based on encoding costs of the one or more candidate search points.

18. The inter-prediction apparatus of claim 17, wherein:
the motion estimation unit configured to derive a point indicated by a combination motion vector based on a plurality of motion vectors based on a zero point of the current block,
wherein the motion estimation unit determines the one or more candidate search points comprising the point indicated by the combination motion vector.

19. The inter-prediction apparatus of claim 17, wherein:
the motion estimation unit configured to determine a specific number of final candidate search points, from among the one or more candidate search points, based on a correlation between motion vectors indicative of the one or more candidate search points,
wherein the motion estimation unit selects the initial search point from a specific number of the final candidate search points.

20. A video encoding method, comprising:
determining one or more candidate search points for a current block;
selecting an initial search point from the one or more candidate search points;
deriving a motion vector of the current block by performing motion estimation within a search range set based on the initial search point;
generating a prediction block by performing prediction on the current block based on the derived motion vector; and
generating a residual block based on the current block and the prediction block and encoding the residual block,
wherein selecting an initial search point from the one or more candidate search points comprises selecting the initial search point based on encoding costs of the one or more candidate search points.
